(19) United States
(12) Patent Application Publication
(10) Pub. No.: US 2022/0406214 A1
(43) Pub. Date: Dec. 22, 2022

(54) METHOD AND SYSTEM FOR AUTOMATIC SCORING READING FLUENCY

(71) Applicant: DAEKYO CO., Ltd., Seoul (KR)

(72) Inventor: Ho Jun KANG, Seoul (KR)

(21) Appl. No.: 17/830,670

(22) Filed: Jun. 2, 2022

(30) Foreign Application Priority Data
Jun. 3, 2021 (KR) 10-2021-0072111

(51) Int. Cl. G09B 17/00; G10L 15/22; G06F 3/16; G10L 15/30; G10L 15/02

(52) U.S. Cl. CPC G09B 17/003; G10L 15/22; G06F 3/167; G10L 15/30; G10L 15/02

(57) ABSTRACT

A method and system for automatic scoring of reading fluency. In some embodiments, the present disclosure provides a method and system for automatic scoring of reading fluency by recording a user's voice reading the passage in a reading fluency question and calculating a reading fluency score indicating how quickly and accurately the user reads texts.

### CROSS-REFERENCE TO RELATED APPLICATIONS

This application is based on, and claims priority from, Korean Patent Application Number 10-2021-0072111, filed Jun. 3, 2021, the disclosure of which is incorporated by reference herein in its entirety.

### TECHNICAL FIELD

The present disclosure in some embodiments relates to a method and system for automatic scoring of reading fluency.

### BACKGROUND

The statements in this section merely provide background information related to the present disclosure and do not necessarily constitute prior art.

Literacy is the ability to solve problems by accessing knowledge and information based on learning a written language. To develop literacy, fast and accurate word recognition is required, which can be judged by the ability to read aloud texts or passages fluently. Therefore, improving literacy takes reading a passage aloud, determining reading fluency for a voice read aloud, and providing immediate feedback on the result of reading fluency. Here, reading fluency is the ability to read texts quickly and accurately, and plays a role in linking word recognition and reading comprehension among reading abilities.

Between the ages of 7 and 8, when children are about to begin formal education, is a period in which early literacy develops, and undeveloped reading fluency at this time would lead to poor learning in the future with a high probability. In South Korea, children start school when they are seven or eight years old while the age of schooling somewhat varies depending on the country, such as five or six years old in the USA.

As a test for diagnosing reading fluency, a text reading test or the like has been used. The text reading test is a test method in which the examiner manually checks the reading speed and accuracy by having the reader read the texts orally, or the examinee reads the texts and fills in the blanks.

However, since the text reading test is not a dedicated test developed for diagnosing reading fluency, there is a limit in accurately diagnosing a learner's reading fluency. Besides, the conventional text reading tests have been developed in consideration of the subject's ‘age’, for example, selecting an official language (e.g., Korean) learning textbook suitable for the subject's grade as a reading text, but they are not performed considering the subject's ‘learning stage’ to users' disappointment.

Additionally, the conventional text reading tests are deficient in that they at best offer a one-off diagnosis due to difficulty with providing immediate feedback on the test result.

### SUMMARY

According to at least one embodiment, the present disclosure provides a method for automatic scoring of reading fluency, including (i) transmitting, by a server, a reading fluency question among multiple reading fluency questions to a user interface, (ii) obtaining voice data by recording, by the user interface, a voice of a user reading a passage in the reading fluency question, (iii) receiving, by the server, the voice data from the user interface and determining a reading speed of the user, determining, by the server, a reading accuracy of the user from the voice data, and (iv) calculating, by the server, a reading fluency score indicating how quickly and accurately the user reads texts, based on the reading speed and the reading accuracy.

According to another embodiment, the present disclosure provides a method for automatic scoring of reading fluency wherein the transmitting of the reading fluency question includes providing the reading fluency questions to render the number of word phrases included in the passage and a total number of the reading fluency questions to be differentiated following learning stages of the user.

According to yet another embodiment, the present disclosure provides a method for automatic scoring of reading fluency further including performing, by the user interface, a feedback provision according to the reading fluency score, and wherein the performing of the feedback provision includes determining whether or not the reading fluency score is equal to or greater than a preset progress criterion, providing the reading fluency question when the reading fluency score is determined to be less than the progress criterion, and providing a subsequent reading fluency question among the multiple reading fluency questions when the reading fluency score is determined to be greater than or equal to the progress criterion.

According to yet another embodiment, the present disclosure provides a system for automatic scoring of reading fluency, including a server configured to determine a reading fluency question among multiple reading fluency questions depending on learning stages of a user and a user interface configured to receive and display the reading fluency question from the server, to obtain voice data by recording a voice of the user reading a passage in the reading fluency question, and to transmit the voice data to the server, wherein the server is configured to determine a reading speed of the user and reading accuracy of the user from the voice data, respectively, and to calculate a reading fluency score indicating how quickly and accurately the user reads texts, based on the reading speed and the reading accuracy.

### BRIEF DESCRIPTION OF THE DRAWINGS

FIG. 1 is a block diagram of an automatic reading-fluency scoring system according to at least one embodiment of the present disclosure.

FIG. 2 is a flowchart of an automatic reading-fluency scoring method according to at least one embodiment of the present disclosure.

FIG. 3 (a) and FIG. 3 (b) illustrates example user interfaces for the acquisition of voice data according to at least one embodiment of the present disclosure.

FIG. 4 is a diagram of an example user interface after completing the acquisition of voice data according to at least one embodiment of the present disclosure.

FIG. 5 (a) and FIG. 5 (b) illustrates example user interfaces for providing feedback of a reading fluency score according to at least one embodiment of the present disclosure.

FIG. 6 is a diagram of an example user interface for implementing the feedback of the reading fluency score by guiding the user to relearn the current reading fluency question according to at least one embodiment of the present disclosure.

### DESCRIPTION OF THE PREFERRED EMBODIMENTS OF THE INVENTION

According to one aspect, the present disclosure seeks to determine, upon receiving the user's voice data, the user's reading speed and reading accuracy according to a preset method, and to calculate and generate the user's reading fluency score based on the user's reading speed and reading accuracy.

According to another aspect, the present disclosure seeks to provide the user with reading fluency questions according to learning stages classified according to a preset criterion.

According to yet another aspect, the present disclosure seeks to provide feedback about the reading fluency diagnosis result by encouraging the user to relearn the outstanding reading fluency question or encouraging the user to proceed with the subsequent one of the reading fluency questions.

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of related known components and functions when considered obscuring the subject of the present disclosure will be omitted for the purpose of clarity and for brevity.

Additionally, various terms such as second, first, etc., are used solely for the purpose of differentiating one component from others but not to imply or suggest the substances, the order, or sequence of the components. Throughout this specification, when parts “include” or “comprise” a component, they are meant to further include other components, not excluding thereof unless there is a particular description contrary thereto. The terms such as “unit,” “module,” and the like refer to units for processing at least one function or operation, which may be implemented by hardware, software, or a combination thereof.

The description of the present disclosure to be presented below in conjunction with the accompanying drawings is intended to describe exemplary embodiments of the present disclosure and is not intended to represent the only embodiments in which the technical idea of the present disclosure may be practiced.

The automatic reading-fluency scoring system of the present disclosure provides reading fluency questions to a user and automatically calculates and generates a reading fluency score by using the voice of the user reading the passage in each reading fluency question. The automatic reading-fluency scoring system of the present disclosure may be an automatic reading-fluency scoring system of an online service branded Daekyo Summit Step Gug-eo (that is Korean language).

In the present disclosure, a user interface is a physical medium or a virtual medium implemented for the purpose of temporary or permanent access to allow interaction between a user and a thing or system (e.g., a device, a computer program, etc.). A user interface may refer, for example, to how a website or application program interacts with a user.

The user interface includes at least one input means that a user can operate and at least one output means that displays a result of the user's use. The user interface may include at least one aspect designed to interact with a user, such as a display screen, a keyboard, a mouse, text, an icon, and tips. The user interface may include, for example, a web user interface (WUI), graphic user interface (GUI), command line interface (CLI), touch user interface, communication interface agent, crossing-based interface, gesture interface, aspect-oriented user interface, movement tracking interface, multi-screen interface, voice user interface, end-user interface, etc., but it is not limited to these particulars.

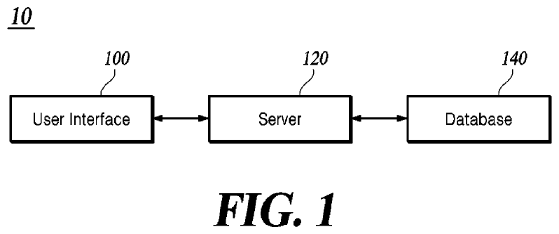

FIG. 1 is a block diagram of an automatic reading-fluency scoring system 10 according to at least one embodiment of the present disclosure.

The automatic reading-fluency scoring system 10 according to at least one embodiment of the present disclosure includes all or part of a user interface 100, a server 120, and a database 140. The automatic reading-fluency scoring system 10 is according to at least one embodiment shown in FIG. 1, and not all components shown in FIG. 1 are requisite components, and some components are added, changed, or deleted in other embodiments. For example, in another embodiment, the database 140 is a component included in the server 120.

Although FIG. 1 shows the automatic reading-fluency scoring system 10 as an apparatus, which is for convenience of description, and the automatic reading-fluency scoring system in another embodiment is implemented as a software module or a processor that performs each of the functions of the components 100, 120, and 140.

The user interface 100 receives reading fluency questions each from the server 120 and displays the same. The reading fluency question includes a passage composed of a preset number of word phrases depending on the user's learning stages or reading fluency stages. The reading fluency question may further include a guiding voice of a third party reading the passage to provide the user with a guide for reading the passage. The guiding voice may be a reading voice of a voice actor, an expert, or the like.

The reading fluency question may further include a reading guide message for a passage or word phrases. The reading guide message is, for example, a message that guides the standard pronunciation of a specific word (e.g., “‘kotbang-gwi’ meaning snort is pronounced as [koppang-gwi or kodppang-gwi].”), a message that guides a user to read a specific word (e.g., “Pay attention to the pronunciation of ‘padakpadak’ meaning flapflap and read it clearly.”), and the like. However, a reading guide message of the present disclosure may include any message formats as long as they present a reading guide message for a passage. The reading fluency question may further include all or part of learning stage information, learning item (or question) information, and learning goal information of that question.

The user interface 100 obtains voice data by recording the voice of the user reading the passage in the reading fluency question. When displaying a reading fluency question, the user interface 100 may display the reading fluency question passage and activate a record button. To improve the reading fluency of the user, the user interface 100 may activate the record button after the user listens to the guiding voice N times (N is a natural number greater than or equal to 1) or more. The user interface 100 may further display all or part of a message guiding the user to read the reading fluency question passage, a learning stage of the provided reading fluency question, a learning item, and a learning goal.

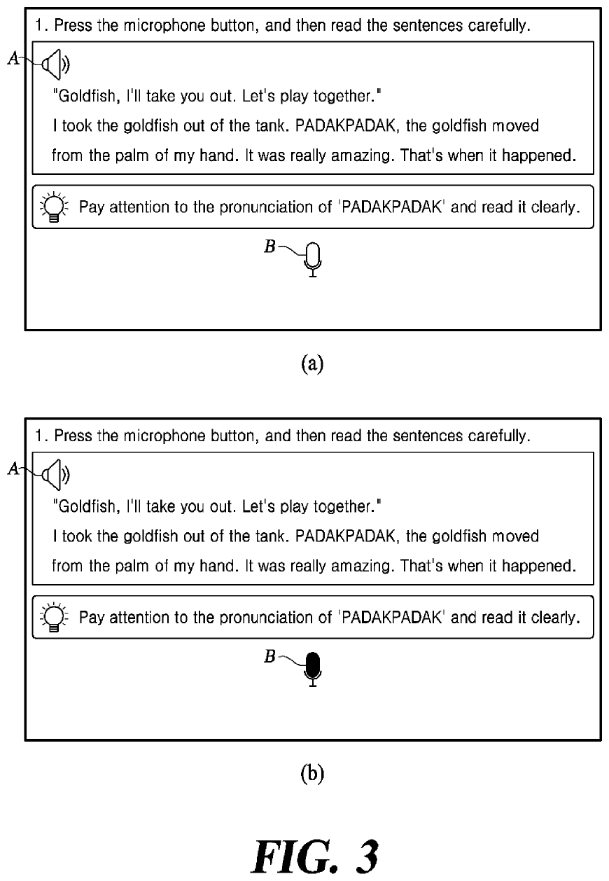

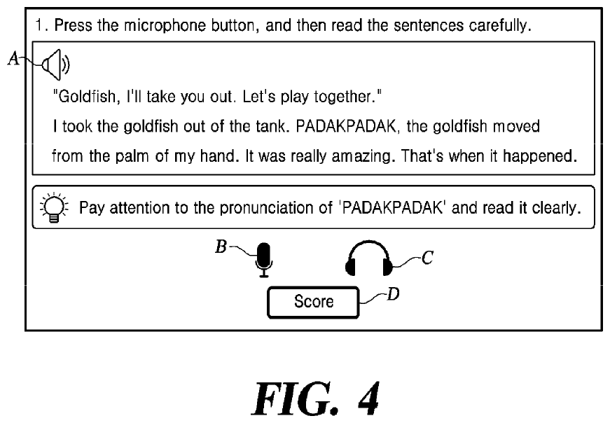

To limit the size of voice data and efficiently calculate the reading fluency score, the user interface 100 may limit the user's recording time. For example, unless the user interface 100 receives a reading end input, e.g., a touch input of a record button, a voice input requesting the end, etc. within a preset time limit after recording starts, the user interface 100 may stop recording and prompt the user to re-record. To request the user to record within the time limit, the user interface 100 may display information related to the time limit or generate an alarm related to the time limit before the end of the time limit. The user interface 100 may further display a voice-data listening button for the user to listen to the user's recorded voice once more. The user interface 100 displays a reading fluency question and obtains voice data as clearly illustrated by FIGS. 3 and 4 which will be described below.

The user interface 100 transmits the obtained voice data to the server 120. The user interface 100 may activate a button for requesting scoring upon completion of the recording, and upon receiving a touch input of the same button, it may transmit the voice data to the server 120.

The user interface 100 may receive and display the reading fluency score calculated by the server 120 and/or feedback on the reading fluency score. For example, the user interface 100 may display a preset feedback message according to the reading fluency score.

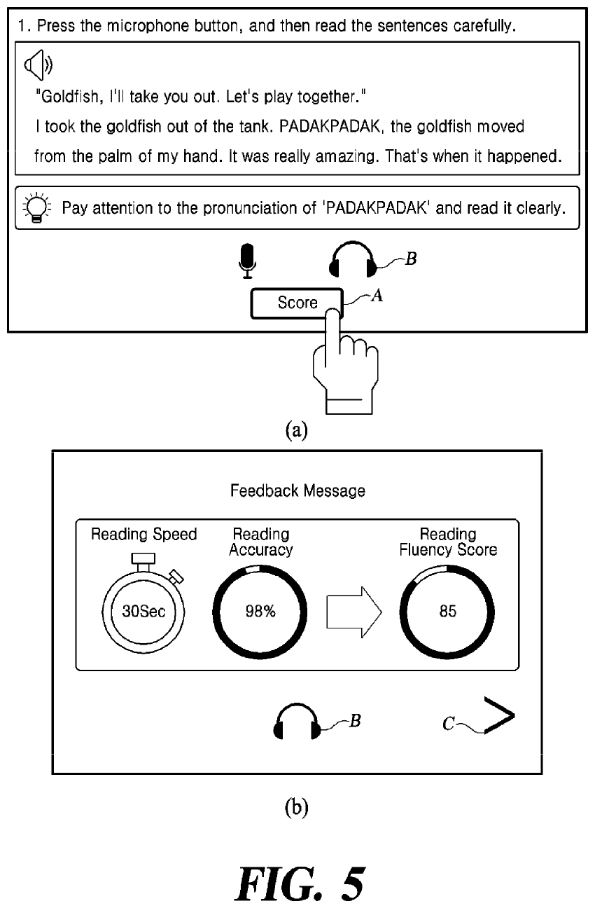

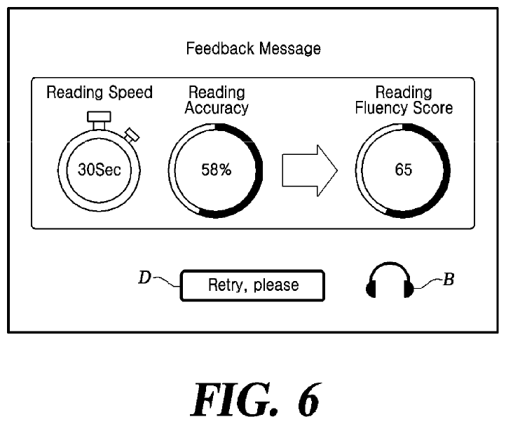

Upon determining that the user's reading fluency score is greater than or equal to a preset progress criterion, the server 120 may transmit the subsequent one of the reading fluency questions to the user interface 100 or transmit a request to proceed with the subsequent one of the reading fluency questions that are stored after being received by the user interface 100. In response, the user interface 100 may display the subsequent reading fluency question or it may display or activate a proceed button that turns up a page on which the subsequent reading fluency question is displayed. Upon determining that the user's reading fluency score is less than the preset progress criterion, the server 120 may request re-learning of the current reading fluency question to the user interface 100 or make a request equivalent thereto. In response, the user interface 100 may display the current reading fluency question again, not display the proceed button, or deactivate the proceed button. The user interface 100 displays a reading fluency score or feedback as clearly illustrated by FIGS. 5 and 6 which will be described below.

On the other hand, when the user interface 100 determines that the reading fluency score is less than the preset progress criterion and displays the current reading fluency question again, it may allow the user to re-record the reading fluency question passage and to obtain a new voice data. To improve the user's reading fluency, the user interface 100 may transmit voice data to the server 120 after recording is performed a preset number of times or more for calculating a reading fluency score. In this case, the user interface 100 may transmit all of the voice data recorded the preset number of times to the server 120 for allowing the same to calculate a reading fluency score for each of the voice data items or calculate reading fluency scores for limited voice data items that meet a preset criterion.

The user interface 100 may display appointed content, e.g., buttons, reading fluency questions, etc. in a simple and concise manner to improve the concentration of the user. For example, the user interface 100 may display each button as an icon indicating a function thereof and may display the reading fluency question passage by using a simple and concise text format.

To improve the reading fluency of the user, the page on which the user interface 100 displays each content may be configured to move to the next page when all conditions are satisfied as requested by that page.

The server 120 transmits the reading fluency question to the user interface 100 upon determining the same depending on the user's learning stages, reading fluency stages, or reading fluency scores. The server 120 receives the voice data from the user interface 100 and calculates the reading fluency score of the user. The server 120 sends the user interface 100 feedback on the reading fluency score based on the same. To determine the reading fluency question among multiple reading fluency questions, the server 120 may have specific data retrieved by inputting a specific condition into the memory in the server 120 or the database 140 accessible to the server 120.

The server 120 may have numbers set for each learning stage, including the number of word phrases included in the reading fluency question passage and the total number of reading fluency questions included in each learning stage or reading fluency stage (hereinafter referred to as “learning stage”). The server 120 may receive and use from the database 140 information on the number of word phrases included in the reading fluency question passage and the total number of reading fluency questions for each learning stage.

The server 120 may determine a reading speed and a reading accuracy, respectively, and calculate a reading fluency score based on the reading speed and the reading accuracy. To quantify the reading speed and the reading accuracy, the server 120 may set the evaluation criterion of the reading speed and the evaluation criterion of the reading accuracy depending on the learning stages, respectively. The server 120 can more accurately calculate the user's reading fluency score by utilizing a word phrase-by-word phase evaluation method instead of the conventional time-based evaluation method.

However, in an experiment conducted by the applicant on the learning stages where the user's initial literacy develops, stepwise strengthening of the reading speed evaluation criteria and the reading accuracy evaluation criteria was found to counteract the calculation of the reading fluency score. This is because qualitative factors such as motivation, interest, and self-confidence act as important factors in improving reading fluency in the early age of literacy development. Therefore, the reading speed evaluation criteria and the reading fluency evaluation criteria are set to be constant for the learning stages in which initial literacy is developed. Table 1 exemplifies the number of word phrases included in the text for each stage of early literacy development (each of stages 3 to 5 in Table 1), the number of provided questions included in the relevant stage, evaluation criteria for reading speed, and evaluation criteria for reading accuracy. The example in Table 1 shows a result of the reading fluency learning experiment by the best possible total numbers of word phrases included in respective passages and the best possible total numbers of questions included in the respective learning stages, as determined for improving the reading fluency of users in the initial stage of literacy development.

TABLE 1

| | Total Word | Total | Reading Speed | |
|---|---|---|---|---|
| Stage | Phrases | Questions | Criteria | Reading Accuracy Criteria |
| 3 4 | 10-15 Word Phrases 15-25 Word Phrases | 63 Questions 30 Questions | 10-30 sec: 50 Points Under 5-10 sec/Over 30 sec-Under 40 sec: 40 Points | $Reading Accuracy = \frac{( 1 - \frac{Misread Word Phrases}{Total Word Phrases} ) \times 100}{2}$ |
| 5 | 25-35 Word Phrases | 30 Questions | Under 1-5 sec/Over 40 sec: 30 Points | |

The server 120 utilizes the preset evaluation criteria of the reading speed to calculate a score of the reading speed for the voice data. The total recording time may be possibly longer than the time the user reads the passage, so the server 120 may recognize the first and last syllables of the reading fluency question passage from the voice data, and calculate a reading speed with the start time of the first syllable and the end time of the last syllable, thereby calculating a reading speed score in proportion to the calculated reading speed. The server 120 utilizes the preset evaluation criteria of the reading accuracy to calculate a reading accuracy score of the user based on the voice data. The server 120 may calculate a score of reading accuracy by determining the number of times of misreading the word phrases included in the voice data.

The server 120 calculates a reading fluency score based on the user's reading speed and reading accuracy. For example, the server 120 may calculate the user's reading fluency score by inputting the reading speed score and the reading accuracy score into a preset reading fluency score calculation formula. Table 2 is an exemplary scheme of calculating a reading fluency score based on a reading speed score and a reading accuracy score.

TABLE 2

| | Reading Fluency | | |
|---|---|---|---|
| Item | Evaluation Score | Speed | Accuracy |
| Score (Best) | 100 Points | 50 Points | 50 Points |
| Proportion | 100% | 50% | 50% |

The server 120 may utilize a scoring model pre-trained to receive voice data and calculate a reading fluency score for determining a reading speed and a reading accuracy, respectively, and thereby calculating a reading fluency score. The scoring model may perform artificial intelligence-based learning. For example, the scoring model may perform learning in a machine learning method including a support vector machine (SVM), clustering, reinforcement learning, a Bayesian network, or the like, or in a deep learning method including an artificial neural network, although the learning method of the scoring model is not limited to these particulars.

The scoring model may learn a user's voice data cumulatively and extract a specific user's misreading feature and/or reading-aloud feature. The scoring model may extract as misreading features, for example, all or part of the number of insertions of new syllables, the number of omissions of syllables included in the passage, the number of nonsense substitutions, the number of semantic substitutions, the number of prolonged sounds ignored, and the number of backward reads. The scoring model may extract as reading-aloud features, for example, all or part of the number of self-corrections, the number of hesitant reads, the number of repeated reads, and the number of sign ignorances. The scoring model may determine a user's reading speed and/or reading accuracy or calculate a reading fluency score based on the extracted misreading features and/or reading-aloud features.

The server 120 determines feedback for the calculated reading fluency score. The server 120 transmits the determined feedback to the user interface 100. Transmission of the feedback suffices as long as information about the feedback is transmitted so that the user interface 100 can display the feedback determined by the server 120, and is not limited to a specific data format.

The server 120 may determine a preset feedback message according to the reading fluency score. The server 120 may send the user interface 100 the content of the feedback message or information, e.g., an identifier of the feedback message. Table 3 is an example of feedback messages for the respective reading fluency scores applicable in the early stages of literacy development.

TABLE 3

| Stage | Reading Fluency Score | Feedback Message |
|---|---|---|
| 3-5 | 100-81 Points | Great Read! |
| | 80-70 Points | Good Read! |
| | Under 70 Points | Practice Regular Reading. |

The server 120 may determine whether the reading fluency score is equal to or greater than a preset progress criterion, and determine the content of the feedback by presenting whether to proceed with the subsequent one of the reading fluency questions. Upon determining that the reading fluency score is equal to or greater than the preset progress criterion, the server 120 sends the user interface 100 the subsequent reading fluency question or a request to proceed to the subsequent reading fluency question. Upon determining that the reading fluency score is less than the preset progress criterion, the server 120 sends the user interface 100 a request to maintain the current reading fluency question or a request to not proceed to the subsequent reading fluency question.

The database 140 stores all or part of the learning stages, reading fluency questions for each learning stage, reading speed evaluation criteria, reading accuracy evaluation criteria, reading fluency score calculation formulas, feedback messages, and progress criteria of whether to proceed to the subsequent reading fluency question. The database 140 may further store all or a part of an identifier of each user and data about each user, including each user's reading fluency score, the reading fluency learning stage where the user is placed, the last learned reading fluency question, the user's reading-aloud features, the user's misreading features, the scoring model that has learned the user's voice data, thereby allowing the automatic reading-fluency scoring system 10 to provide the user with a customized automatic reading-fluency scoring service.

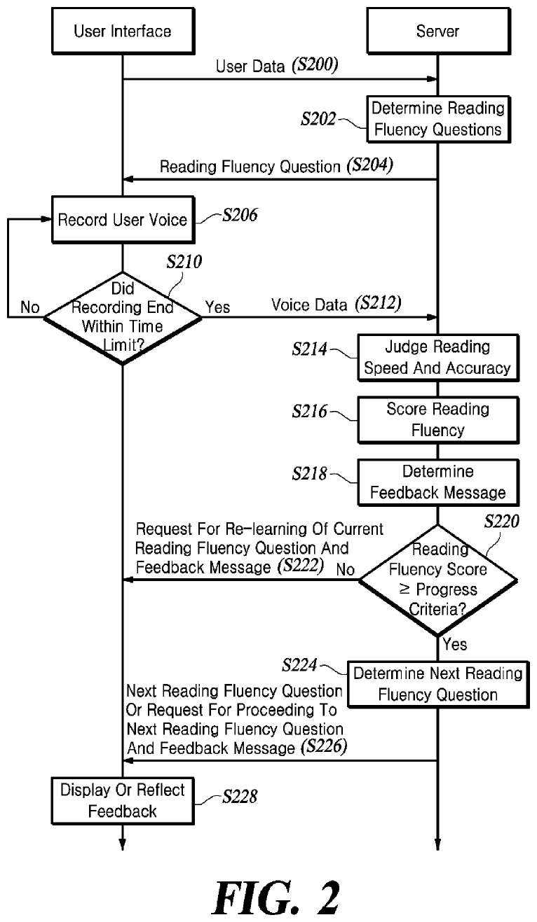

FIG. 2 is a flowchart of an automatic reading-fluency scoring method according to at least one embodiment of the present disclosure.

The user interface transmits user data, e.g., user identifier, user age, user learning level, user preference, etc. to the server (Step S200). Step S200 may be performed just once for the first time that the user accesses the user interface, and may be omitted for subsequent access.

The server determines the reading fluency questions to be transmitted to the user interface based on the user data (S202). When the server uses user information stored in its internal memory or a database accessible by the server, Step S200 may be omitted and the user information in the memory or database may be used to perform Step S202.

The server transmits the reading fluency question determined by Step S202 to the user interface (S204). However, in case the user interface has already received and stored all or part of the reading fluency questions, the server may send the information, e.g., identifiers, etc. of the reading fluency questions determined in Step S202 to the user interface for the same to display those reading fluency questions.

The user interface displays a reading fluency question and records the voice of the user reading the reading fluency question passage (S206).

The user interface determines whether the recording in Step S206 has ended within the time limit (S210).

Upon determining in Step S210 that the recording has not ended within the time limit, the user interface returns to Step S206 to re-record the user's voice.

Upon determining in Step S210 that the recording has ended within the time limit, the user interface transmits the voice data recorded by the user to the server (S212).

The server determines the user's reading speed and reading accuracy based on the voice data received in Step S212 (S214).

The server calculates the user's reading fluency score based on the user's reading speed and reading accuracy (S216).

The server determines a feedback message as a feedback operation to the calculated reading fluency score (S218).

The server determines whether the reading fluency score is greater than or equal to a preset progress criterion (S220).

Upon determining in Step S220 that the reading fluency score is less than the progress criterion, the server sends the user interface a request for re-learning of the reading fluency question indicated in Step S204 and the feedback message determined in Step S218 (S222).

Upon determining in Step S220 that the reading fluency score is greater than or equal to the progress criterion, the server determines the subsequent one to proceed with learning among the reading fluency questions (S224). However, when the next reading fluency question in order has already been determined, Step S224 may be omitted.

The server sends the user interface the subsequent reading fluency question or a request for proceeding to the subsequent reading fluency question and the feedback message determined in Step S218 (S226).

The user interface displays the feedback message transmitted in Step S222 or the feedback message transmitted in Step S226 or makes an output reflecting the request in the feedback message (S228).

Although FIG. 2 presents the respective steps thereof as being sequentially performed, it merely instantiates the technical idea of some embodiments of the present disclosure. Therefore, a person having ordinary skill in the pertinent art could incorporate various modifications, additions, and substitutions in practicing the present disclosure by changing the sequence of steps illustrated by FIG. 2 or by performing one or more of the steps thereof in parallel, and hence the steps in FIG. 2 are not limited to the illustrated chronological sequences.

FIG. 3(a) and FIG. 3(b) illustrate example user interfaces for the acquisition of voice data according to at least one embodiment of the present disclosure.

As shown in FIG. 3(a), the user interface may display the received reading fluency item (or question), along with a reading fluency item passage and a message guiding the user to record a voice reading the passage. For allowing the user to listen first to a guiding voice of reading the passage and then perform recording, the user interface activates a guiding voice button A in FIG. 3(a) and (b) and deactivates a record button B in FIG. 3 (a) and FIG. 3(b).

As shown in FIG. 3(b), when the user completes listening to the guiding voice, the user interface activates the record button B so that the user can record the voice.

FIG. 4 is a diagram of an example user interface after completing the acquisition of voice data according to at least one embodiment of the present disclosure.

As shown in FIG. 4, when the user completes the voice recording within the time limit, the user interface activates a listen button at C for the user to listen to the user's recorded voice. The user interface activates a score button at D for allowing the user to obtain a reading fluency score for the voice data of the recorded voice. Even after the user's recording is completed, the user interface may activate the record button at B for allowing the user to re-record. Even after the user's recording is completed, the user interface may activate the guiding voice button at A for allowing the user to listen to the guiding voice.

FIG. 5 (a) and FIG. 5(b) illustrate example user interfaces for providing feedback of a reading fluency score according to at least one embodiment of the present disclosure.

As shown in FIG. 5(a), after the user completes the voice recording, when the user interface receives an input of a score button at A, it sends out voice data of the voice recording to the server. The server calculates the reading fluency score of the user based on the voice data and transmits the reading fluency score and feedback corresponding to the score to the user interface.

As shown in FIG. 5(b), upon receiving the feedback from the server, the user interface displays a feedback message regarding the feedback along with the reading fluency score. Since the reading fluency score is calculated based on the user's reading speed and reading accuracy, the user interface may display the user's reading speed (or reading time) and reading accuracy together. For allowing the user to listen to the user's recorded voice, the user interface activates the listen button at B. When the user's reading fluency score is equal to or greater than the progress criterion, the user interface activates a proceed button at C to turn to the page on which the subsequent reading fluency question is displayed.

FIG. 6 is a diagram of an example user interface for implementing the feedback of the reading fluency score by guiding the user to relearn the current reading fluency question according to at least one embodiment of the present disclosure.

As shown in FIG. 6, when the user's reading fluency score is less than the progress criterion, the user interface activates a retry button at D for prompting the user to re-record the current reading fluency question. For allowing the user to recognize the problem by listening to the user's recorded voice, the user interface activates the listen button at B.

According to one aspect, the present disclosure can determine, upon receiving user's voice data, the user's reading speed and reading accuracy according to a preset method, and calculate and generate the user's reading fluency score based on the user's reading speed and reading accuracy, whereby diagnosing the user's reading fluency automatically and accurately.

According to another aspect, the present disclosure can provide reading fluency questions according to learning stages classified according to a preset criterion, whereby diagnosing reading fluency by taking account of the user's learning stage.

According to yet another aspect, the present disclosure can provide feedback about the reading fluency diagnosis result by encouraging the user to relearn the outstanding reading fluency question or encouraging the user to proceed with the subsequent one of the reading fluency questions, whereby improving the reading fluency of the user efficiently.

Various implementations of the apparatuses, units, processes, steps, and the like described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. Computer programs, which are also known as programs, software, software applications, or codes, contain instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording medium further includes transitory media such as data transmission medium. Further, the computer-readable recording medium can be distributed in computer systems connected via a network, wherein the computer-readable codes can be stored and executed in a distributed mode.

Various implementations of the systems and techniques described herein can be realized by a programmable computer. Here, the computer includes a programmable processor, a data storage system (including volatile memory, nonvolatile memory, or any other type of storage system or a combination thereof), and at least one communication interface. For example, the programmable computer may be one of a server, network equipment, a set-top box, an embedded device, a computer expansion module, a personal computer, a laptop, a personal data assistant (PDA), a cloud computing system, and a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A method for automatic scoring of reading fluency, the method comprising:
transmitting, by a server, a reading fluency question among multiple reading fluency questions to a user interface;
obtaining voice data by recording, by the user interface, a voice of a user reading a passage in the reading fluency question;
receiving, by the server, the voice data from the user interface and determining a reading speed of the user;
determining, by the server, a reading accuracy of the user from the voice data; and
calculating, by the server, a reading fluency score indicating how quickly and accurately the user reads texts, based on the reading speed and the reading accuracy.

2. The method of claim 1, wherein the transmitting of the reading fluency question comprises:
providing the reading fluency questions to render a number of word phrases included in the passage and a total number of the reading fluency questions to be differentiated following learning stages of the user.

3. The method of claim 1, wherein the transmitting of the reading fluency question comprises:
transmitting a guiding voice of reading the passage along with the reading fluency question, and
wherein the obtaining of the voice data is performed upon completion of reproduction of the guiding voice.

4. The method of claim 1, wherein the obtaining of the voice data comprises:
when no reading end input is received by the user interface within a preset time limit, ending the recording, and restarting, by the user interface, recording of a voice of the user reading the passage in the reading fluency question.

5. The method of claim 1, wherein the determining of the reading accuracy comprises:
determining a number of misreads of word phrases included in the voice data, and calculating a score of the reading accuracy based on the number of misreads.

6. The method of claim 1, further comprising performing, by the user interface, a feedback provision according to the reading fluency score.

7. The method of claim 6, wherein the performing of the feedback provision comprises:
determining whether or not the reading fluency score is equal to or greater than a progress criterion that is preset, providing the reading fluency question when the reading fluency score is determined to be less than the progress criterion, and providing a subsequent reading fluency question among the multiple reading fluency questions when the reading fluency score is determined to be greater than or equal to the progress criterion.

8. A system for automatic scoring of reading fluency, the system comprising:
a server configured to determine a reading fluency question among multiple reading fluency questions depending on learning stages of a user; and
a user interface configured to receive and display the reading fluency question from the server, to obtain voice data by recording a voice of the user reading a passage in the reading fluency question, and to transmit the voice data to the server,
wherein the server is configured to determine a reading speed of the user and a reading accuracy of the user from the voice data, respectively, and to calculate a reading fluency score indicating how quickly and accurately the user reads texts, based on the reading speed and the reading accuracy.

9. The system of claim 8, wherein the server is configured to feedback to the user interface based on the reading fluency score.

10. The system of claim 9, wherein the server is configured to determine whether or not the reading fluency score is equal to or greater than a preset progress criterion, to implement the feedback by requesting the user interface for re-learning of the reading fluency question upon determining that the reading fluency score is less than the preset progress criterion, and to implement the feedback by requesting the user interface for proceeding to a subsequent one of the reading fluency questions upon determining that the reading fluency score is greater than or equal to the preset progress criterion.

11. The system of claim 8, wherein the server is configured to use a scoring model that has been pre-trained to receive voice data and calculate a reading fluency score, to determine the reading speed and the reading accuracy, respectively, and to calculate the reading fluency score.

12. The system of claim 11, wherein the user interface is configured to restart recording of a voice of the user reading the passage to obtain new voice data, and to transmit the new voice data to the server.

13. The system of claim 12, wherein the scoring model is configured to cumulatively learn voice data of the user, to extract both or either one of misreading features of the user and reading-aloud features of the user, and to determine the reading speed and the reading accuracy based on both or either one of the misreading features and the reading-aloud features.
